(19) United States
(12) Patent Application Publication
(10) Pub. No.: US 2010/0231465 A1
(43) Pub. Date: Sep. 16, 2010

(54) IN-VEHICLE DEVICE AND COMMUNICATION METHOD

(75) Inventor: Akitomo Tanaka, Amagasaki-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shi (JP)

(21) Appl. No.: 12/709,357

(22) Filed: Feb. 19, 2010

(30) Foreign Application Priority Data
Mar. 10, 2009 (JP) 2009-056568

(51) Int. Cl. H01Q 1/32; G06F 7/04

(52) U.S. Cl. 343/711; 340/5.61

(57) ABSTRACT

An in-vehicle device transmits a response request signal to inside and outside of a vehicle and performs a predetermined control when receiving a response signal from a specific portable device. The in-vehicle device includes a plurality of antennas installed inside the vehicle, a transmission unit configured to modulate the response request signal with a predetermined carrier wave and transmit the signal from the plurality of antennas, and a phase difference control unit configured to shift a phase of the carrier wave corresponding to each of the plurality of antennas when modulating the response request signal with the predetermined carrier wave in the transmission unit

### BACKGROUND OF THE INVENTION

1. Technical Field

The present invention relates to an in-vehicle device and a communication method.

2. Related Art

A so-called a passive entry system, which automatically performs predetermined controls such as opening and closing of a door of an automobile etc., or starting and stopping of an engine without inserting a key, is conventionally put to practical use. As shown in FIG. 6, when communicating with a portable device 2 existing in a vehicle 1, the conventional passive entry system transmits a signal for requesting a response to the portable device 2 with a vehicle interior (LF: Low Frequency) antenna 3 of the in-vehicle device (not shown), and responds by UHF (Ultra High Frequency) when the portable device 1 normally receives a response signal.

In this case, whether the portable device 2 exists inside or outside the vehicle needs to be determined precisely to prevent the portable device 2 from being mislaid, or the like, and a technique of arranging a vehicle interior antenna 3 and a vehicle exterior antenna 4, requesting responses to the portable device 2 for plural times from each of the vehicle interior antenna 3 and the vehicle exterior antenna 4, and determining that the portable device 2 exists on the side with more responses is proposed (e.g., Japanese Unexamined Patent Publication No. 2003-3710).

A setting for having a communication area of the vehicle interior antenna 3 even is required with respect to the actual area in the vehicle to determine precisely that the portable device 2 exists inside the vehicle. As shown in FIG. 7A, the communication area normally does not spread evenly with one vehicle interior antenna 3 and a non-communication area tends to exist. Since a realization of making the communication area even is difficult with one vehicle interior antenna 3, the communication area is evened by installing a plurality of vehicle interior antennas (LF antenna) 3-1 and 3-2, as shown in FIG. 7B (e.g., Japanese Unexamined Patent Publication No. 2005-76329).

### SUMMARY

In the above conventional techniques, with a portion where communication areas of a plurality of vehicle interior antennas 3-1 and 3-2 overlap as one area, transmission data are divided into plurals and transmitted from a plurality of vehicle interior antennas 3-1 and 3-2, as shown in FIG. 8A. However, since response request signals are transmitted at different timings from a plurality of vehicle interior antennas 3-1 and 3-2 installed inside the vehicle, there is a problem in that a processing time for the number of vehicle interior antennas is required.

To reduce the response time, consideration is made in simultaneously operating a plurality of vehicle interior antennas 3-1 and 3-2 with the portion where the communication areas of a plurality of vehicle interior antennas 3-1 and 3-2 overlap as the respective communication area, as shown in FIG. 8B. In this case, however, there is a problem of “dead-band” caused by the collision of signals transmitted from a plurality of vehicle interior antennas 3-1 and 3-2. That is, as shown in FIG. 9, the level lowers when magnetic fields from a plurality of vehicle interior antennas 3-1 and 3-2 interfere with each other. The “dead-band” refers to a place where magnetic field lines are canceled out by magnetic field lines of different directions, and is also called as a signal dead-band.

One or more embodiments of the present invention provide an in-vehicle device and a communication method capable of reducing the processing time while suppressing the dead-band.

In accordance with one aspect of the present invention, the present invention relates to an in-vehicle device that transmits a response request signal to inside and outside of a vehicle, and performs a predetermined control when receiving a response signal from a specific portable device, the in-vehicle device including: a plurality of antennas installed inside the vehicle, a transmission unit for modulating the response request signal with a predetermined carrier wave and transmitting the signal from the plurality of antennas; and a phase difference control unit for shifting a phase of the carrier wave corresponding to each of the plurality of antennas when modulating the response request signal with the predetermined carrier wave in the transmission unit.

Further, according to one or more embodiments, the phase difference control unit performs a control of giving a phase difference of π/n (n=number of antennas) to the carrier wave corresponding to each of the plurality of antennas.

Further, according to one or more embodiments, the plurality of antennas is at least two.

Further, according to one or more embodiments, the response request signal is a low-frequency signal.

In accordance with another aspect of the present invention, the present invention relates to a communication method between an in-vehicle device and a specific portable device, the in-vehicle device transmitting a response request signal to inside and outside of a vehicle and performs a predetermined control when receiving a response signal from a specific portable device, the communication method comprising the steps of: modulating the response request signal with a predetermined carrier wave in the in-vehicle device and transmitting the signal from a plurality of antennas installed inside the vehicle; and shifting a phase of the carrier wave corresponding to each of the plurality of antennas when modulating the response request signal with the predetermined carrier wave.

Further, according to one or more embodiments, the step of shifting the phase includes giving a phase difference of π/n (n=number of antennas) to the carrier wave corresponding to each of the plurality of antennas when modulating the response request signal with the predetermined carrier wave.

Further, according to one or more embodiments, the plurality of antennas is at least two.

Further, according to one or more embodiments, the response request signal is a low-frequency signal.

According to this invention, an advantage in that the processing time can be reduced while suppressing the dead-band is obtained since a phase difference of π/n (n=number of antennas) from each other is provided to the response request signals transmitted from each of a plurality of vehicle interior antennas.

### BRIEF DESCRIPTION OF THE DRAWINGS

FIG. 1 is a block diagram showing a configuration of a passive entry system and an in-vehicle device according to an embodiment of the present invention;

FIG. 2 is a conceptual diagram showing a signal level of LF signals (response request signal) from vehicle interior antennas 14-1 and 14-2 by the in-vehicle device 10 of the present embodiment;

FIG. 3 is a conceptual diagram showing a magnetic field of the LF signals (response request signal) by the in-vehicle device of the conventional technique;

FIG. 4 is a conceptual diagram showing the magnetic field of the LF signals (response request signal) by the in-vehicle device of the present invention;

FIGS. 5A and 5B are schematic views showing a result of an electromagnetic field simulation in the vehicle when three vehicle interior antennas are arranged;

FIG. 6 is a block diagram showing one example of the passive entry system for automatically performing opening and closing of a vehicle door, or starting and stopping of an engine without inserting a key;

FIGS. 7A and 7B are conceptual diagrams for describing one example of a communication area of the passive entry system;

FIGS. 8A and 8B are conceptual diagrams describing a communication method between the in-vehicle device and a portable device by the passive entry system; and

FIG. 9 is a conceptual diagram showing a lowering in level by interference of the magnetic fields from the vehicle interior antennas.

### DETAILED DESCRIPTION

Hereinafter, embodiments of the present invention will be described with reference to the drawings.

### A. Configuration of the Embodiment

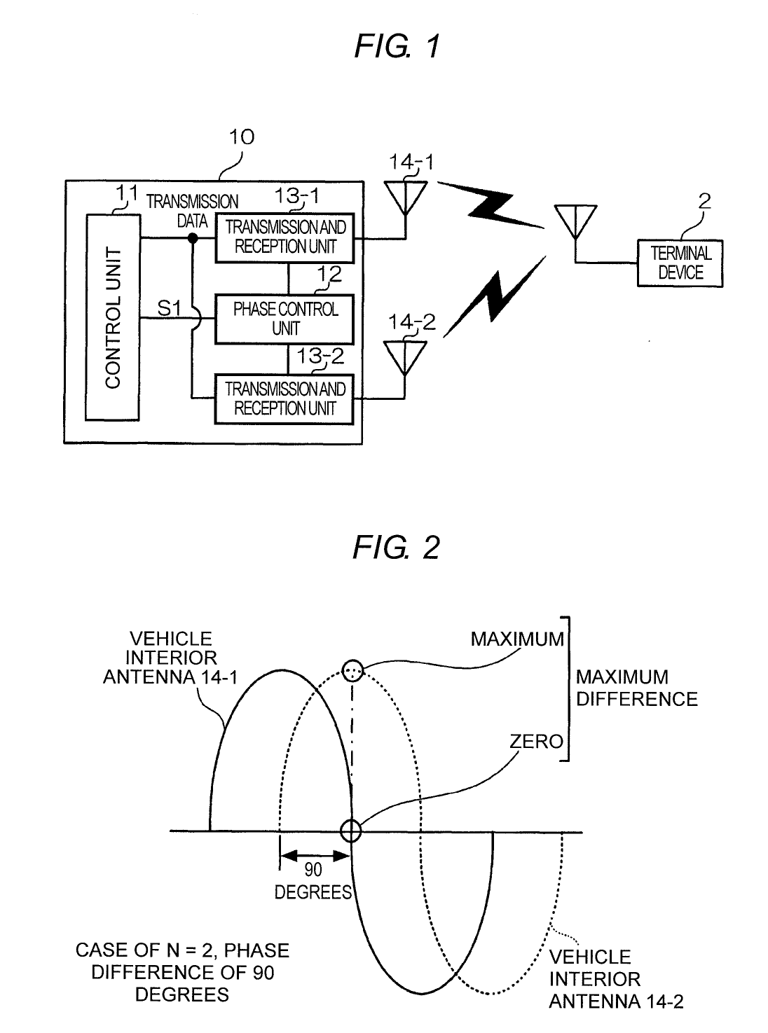

FIG. 1 is a block diagram showing a configuration of a passive entry system and an in-vehicle device. In the figure, an in-vehicle device 10 includes a control unit 11, a phase control unit 12, transmission and reception units 13-1 and 13-2, and vehicle interior antennas 14-1 and 14-2. The explanation of the terminal device 2 is omitted since it is same as the conventional technique.

The control unit 11 controls the operation of each unit in transmission and reception of data, and performs a predetermined control such as opening and closing of a vehicle door, or starting and stopping of an engine according the position of the portable device 2 when receiving a response signal from the specific portable device 2. The phase control unit 12 controls a phase difference in the transmission and reception units 13-1 and 13-2 of the transmission data according to a control signal S1 from the control unit 11. When modulating the transmission data (LF signal; response request signal) from the control unit 11, the transmission and reception units 13-1 and 13-2 respectively transmit the transmission data from the corresponding vehicle interior antennas 14-1 and 14-2, with a phase difference of π/n (n=number of antennas) from each other, according to the control from the phase control unit 12.

The process in the phase control unit 12 and the transmission and reception units 13-1 and 13-2 described above can be generalized as the following. The phase difference of π/n is given to the LF signals (response request signal) transmitted at the same timing from each n vehicle interior antennas.

=180 degree
Example: When n=2, phase difference is 90 degree. When n=3, phase difference is 60 degrees.

FIG. 2 is a conceptual diagram showing a signal level of the LF signals (response request signal) from the vehicle interior antennas 14-1 and 14-2 by the in-vehicle device 10 of the present embodiment. A dead-band is completely eliminated when the phase difference is 90 degrees at n=2. The dead-band is not completely eliminated but is suppressed when the phase difference is 60 degrees at n=3.

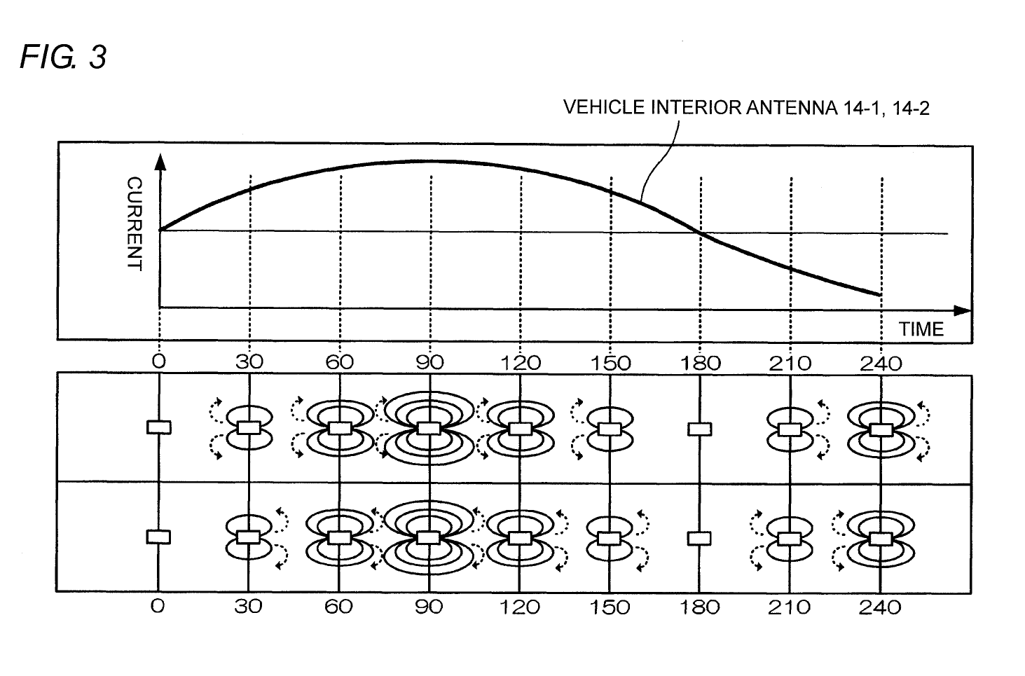

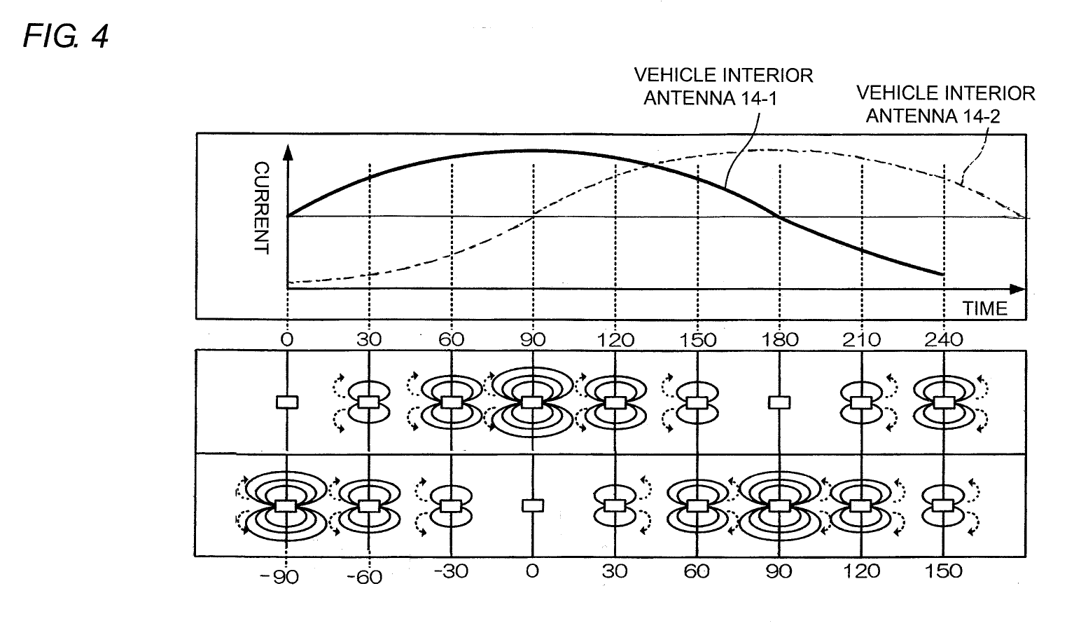

FIG. 3 is a conceptual diagram showing a magnetic field of the LF signals (response request signal) by the in-vehicle device of the conventional technique. FIG. 4 is a conceptual diagram showing the magnetic field of the LF signals (response request signal) by the in-vehicle device of the present invention. In the conventional technique, as shown in FIG. 3, directions of the magnetic field lines from the vehicle interior antennas 14-1 and 14-2 are opposite and magnetic field intensity becomes a maximum at the same timing, and thus a current level lowers as a result of the magnetic field lines greatly interfering with each other thereby producing the “dead-band”.

In the present invention, as shown in FIG. 4, the directions of the magnetic field lines from the vehicle interior antennas 14-1 and 14-2 are opposite and interfere with each other to no small extent, but the interference is small and the production of “dead-band” can be suppressed since timings when the magnetic field intensity becomes a maximum are different.

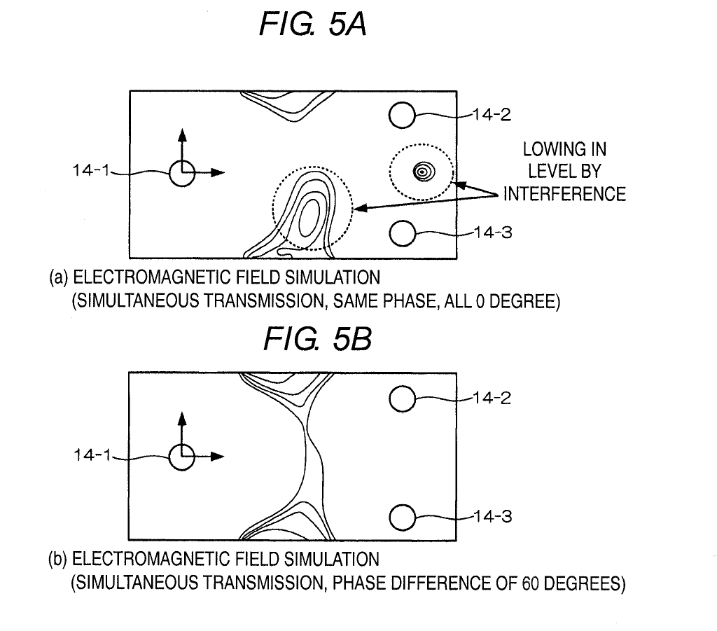

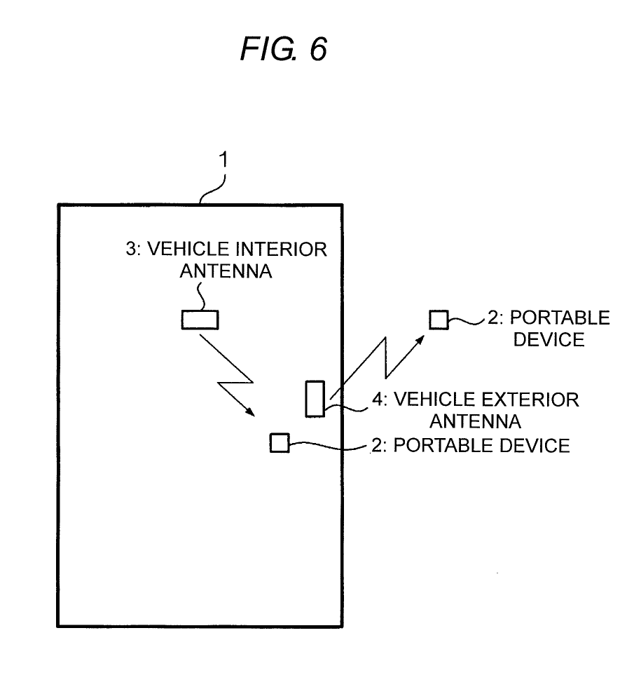

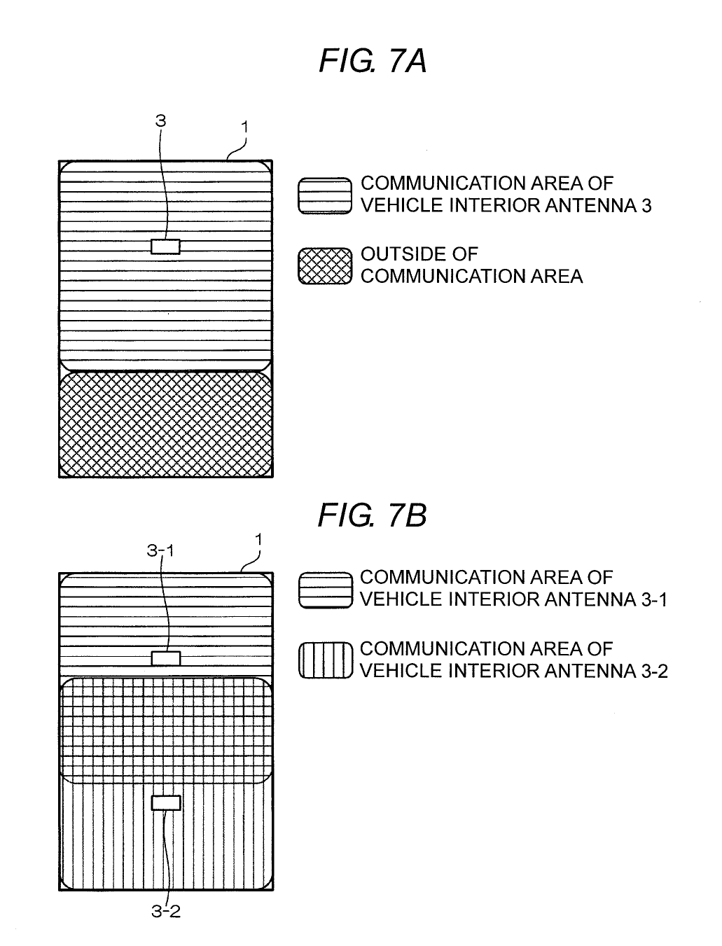

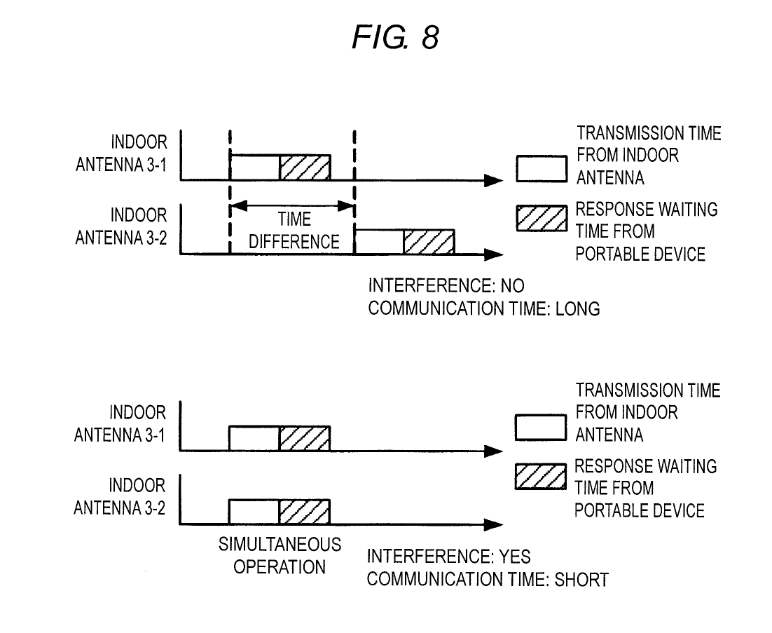

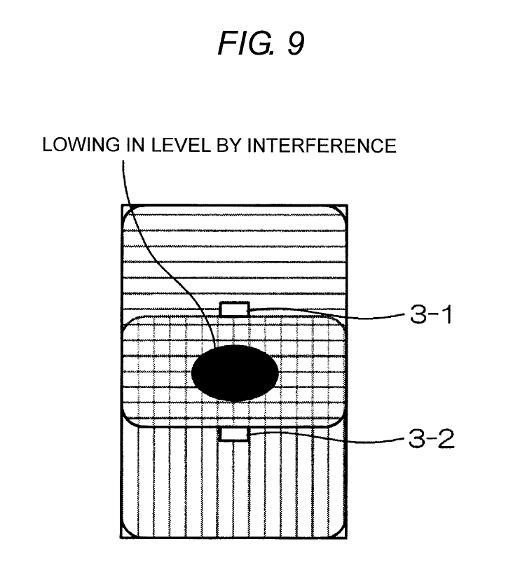

FIGS. 5A and 5B are schematic views showing the result of an electromagnetic field simulation in the vehicle when three vehicle interior antennas are arranged. FIG. 5A is a case in which the conditions of the simulation is such that three vehicle interior antennas 14-1 to 14-3 are arranged at the illustrated positions, the transmissions are simultaneous, and the phases are the same (vehicle interior antennas 14-1, 14-2, 14-3=0°). In other words, this case corresponds to the conventional technique. In this case, lowering in current level by interference is seen at an encircled part.

FIG. 5B is a case in which the conditions of the simulation is such that three vehicle interior antennas 14-1 to 14-3 are arranged at the illustrated positions, the transmissions are simultaneous, and the phase difference is 60° (vehicle interior antennas 14-1=0°, 14-2=60°, 14-3=120°). This case corresponds to the present embodiment. In this case, influence by interference is reduced and lowering in current level is significantly reduced.

According to the embodiment described above, the interference of the magnetic field transmitted from a plurality of LF antennas can be reduced and lowering in current level can be reduced by shifting the phase of a carrier wave used in a plurality of vehicle interior antennas.

1. An in-vehicle device that transmits a response request signal to inside and outside of a vehicle and performs a predetermined control when receiving a response signal from a specific portable device, the in-vehicle device comprising:
a plurality of antennas installed inside the vehicle;
a transmission unit configured to modulate the response request signal with a predetermined carrier wave and transmit the signal from the plurality of antennas; and
a phase difference control unit configured to shift a phase of the carrier wave corresponding to each of the plurality of antennas when modulating the response request signal with the predetermined carrier wave in the transmission unit.

2. The in-vehicle device according to claim 1, wherein the phase difference control unit performs a control of giving a phase difference of π/n (n=number of antennas) to the carrier wave corresponding to each of the plurality of antennas.

3. The in-vehicle device according to claim 1, wherein the plurality of antennas is at least two.

4. The in-vehicle device according to claim 1, wherein the response request signal is a low-frequency signal.

5. A communication method between an in-vehicle device and a specific portable device, the in-vehicle device transmitting a response request signal to inside and outside of a vehicle and performing a predetermined control when receiving a response signal from a specific portable device, the communication method comprising the:
modulating the response request signal with a predetermined carrier wave in the in-vehicle device and transmitting the signal from a plurality of antennas installed inside the vehicle; and
shifting a phase of the carrier wave corresponding to each of the plurality of antennas when modulating the response request signal with the predetermined carrier wave.

6. The communication method according to claim 5, wherein the shifting includes giving a phase difference of π/n (n=number of antennas) to the carrier wave corresponding to each of the plurality of antennas when modulating the response request signal with the predetermined carrier wave.

7. The communication method according to claim 5, wherein the plurality of antennas is at least two.

8. The communication method according to claim 5, wherein the response request signal is a low-frequency signal.

9. The in-vehicle device according to claim 2, wherein the plurality of antennas is at least two.

10. The in-vehicle device according to claim 2, wherein the response request signal is a low-frequency signal.

11. The in-vehicle device according to claim 3, wherein the response request signal is a low-frequency signal.

12. The communication method according to claim 6, wherein the plurality of antennas is at least two.

13. The communication method according to claim 6, wherein the response request signal is a low-frequency signal.

14. The communication method according to claim 7, wherein the response request signal is a low-frequency signal.
